(19) United States
(12) Patent Application Publication
(10) Pub. No.: US 2008/0268677 A1
(43) Pub. Date: Oct. 30, 2008

(54) NETWORK DEVICE AND CONNECTION MODULE THEREOF

(76) Inventor: Han-Cheng HSU, Taoyuan Hsien (TW)

Correspondence Address: BIRCH STEWART KOLASCH & BIRCH, PO BOX 747, FALLS CHURCH, VA, 22040-0747, US

(21) Appl. No.: 12/027,832

(22) Filed: Feb. 7, 2008

(30) Foreign Application Priority Data
Apr. 27, 2007 (TW) 096114953

(51) Int. Cl. H01R 4/66

(52) U.S. Cl. 439/92; 439/620.15; 439/607

(57) ABSTRACT

A connecting module includes at least a connector, a circuit board, a network element and a housing. The connector is electrically connected to a first side of the circuit board. The network element is electrically connected to a second side of the circuit board. The connector and the network element are accommodated in the housing.

### CROSS REFERENCE TO RELATED APPLICATIONS

This Non-provisional application claims priority under 35 U.S.C. §119(a) on Patent Application No(s). 096114953 filed in Taiwan, Republic of China on Apr. 27, 2007, the entire contents of which are hereby incorporated by reference.

### BACKGROUND OF THE INVENTION

1. Field of Invention

The invention relates to a network device and a connector and, in particular, to a network device and a connection module thereof integrating a network chip and a connector.

2. Related Art

Due to the fast development of information technology, computers are widespread used. In addition, under the fast development of Internet technology, computers can rapidly obtain required information and provide various information services through Internet. Therefore, it has been a trend of the information age to connect computers or peripheral apparatuses through network.

As shown in FIG. 1, a conventional network device 1 includes a connector 11, a network element 12 and a circuit board 13. The connector 11 is connected to electronic apparatuses (such as computers or peripherals) located separately to receive various signals and information. As shown in FIG. 1, the connector 11 includes a main body 111 and a housing 112 covering the main body 111. The main body 111 has a plurality of terminals 113 and a plurality of pins 114. The housing 112 has an RJ (Registered Jack) connection hole 115 and/or a USB (Universal Serial Bus) connection hole 116. The terminals 113 are disposed corresponding to the connection hole 115. The pins 114 are disposed on the bottom of the main body 111 and penetrate through the housing 112. Each of the terminals 113 is electrically connected to the corresponding pin 114. Therefore, the network signals can be received and transmitted through the terminals 113 and pins 114 when a connection plug of a connection line is inserted into the connection hole 115 or 116 of the connector 11.

The connector 11 is electrically connected to the network element 12 through the pins 114 of the connector 11 and the circuit board 13. The network element 12 transforms the signals and information received by the connector 11, and then outputs them.

However, because the connector 11 and the network element 12 are disposed on the circuit board 13 separately, a certain area of the circuit board 13 must be occupied. This design can not meet the requirement of microminiaturization of electronic apparatuses. Furthermore, there will be noises produced when analog signals are transformed to digital signal, which affects the efficiency of the whole system and results to the EMI (Electro-Magnetic Interference). Nowadays, the connector 11 and the network element 12 must be designed separately to prevent EMI, hence increasing the complexity of the manufacturing process and the manufacturing cost.

Therefore, there is a need to provide a network device and a connection module thereof that can integrate the connector and the network element so as to achieve microminiaturization, simplify the circuit layout and prevent EMI.

### SUMMARY OF THE INVENTION

In view of the foregoing, an object of the invention is to provide a network device and a connection module thereof that can integrate the connector and the network element so as to achieve microminiaturization, simplify the circuit layout and prevent EMI.

To achieve the above, the invention discloses a connection module including at least a connector, a circuit board, a network element and a housing. The connector is electrically connected to a first side of the circuit board. The network element is electrically connected to a second side of the circuit board and disposed opposite to the connector. The connector and the network element are accommodated in the housing.

In one aspect of the invention, the connection module further includes a first connector and a second connector, which are disposed adjacent to each other and on the circuit board.

In one aspect of the invention, the first connector has a connection hole such as an RJ-45 connection hole, an RJ-11 connection hole, an RJ-12 connection hole or any other type of connection hole. The second connector includes a USB transmission interface.

In one aspect of the invention, the network element includes a carrying element and a network chip. The carrying element is used to carry the network chip. The network chip is a physical layer (PHY) chip applied to a physical layer processing apparatus.

In one aspect of the invention, the housing includes an EMI shielding material. Alternatively, an EMI shielding material can be formed on the surface of the housing. The EMI shielding material includes metal or alloy.

In addition, to achieve the above, the invention also discloses a network device including a first circuit board and a connection module coupled with the first circuit board. The connection module includes at least a connector, a second circuit board, a network element and a housing. The connector is electrically connected to a first side of the second circuit board. The network element is electrically connected to a second side of the second circuit board. The housing accommodates the connector and the network element.

As mentioned above, the network element and the connection module of the invention are integrated on one circuit board. Thus, the network device and connection module of the invention can be easy assembled and prevent the EMI.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic view of a conventional network device;

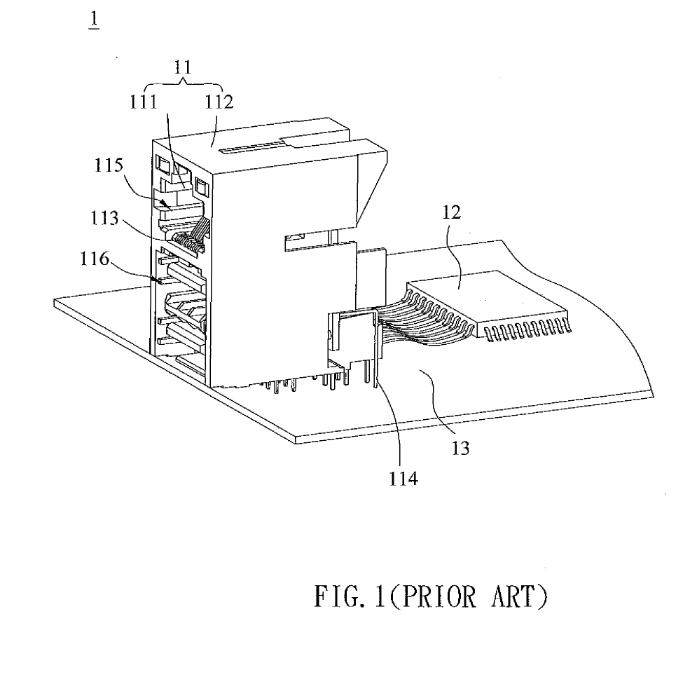

FIG. 2 is an exploded diagram of a connection module according to an embodiment of the invention;

FIG. 3 is a schematic diagram of the first connector, the second connector and the network element of FIG. 2; and

FIG. 4 is a schematic diagram of a network device according to the embodiment of the invention.

### DETAILED DESCRIPTION OF THE INVENTION

The present invention will be apparent from the following detailed description, which proceeds with reference to the accompanying drawings, wherein the same references relate to the same elements.

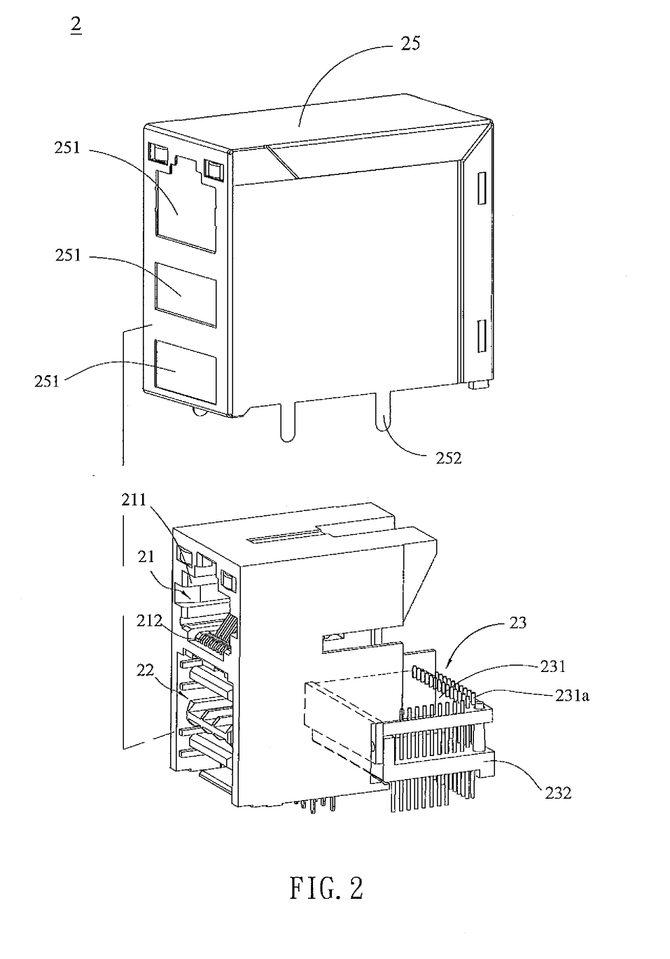

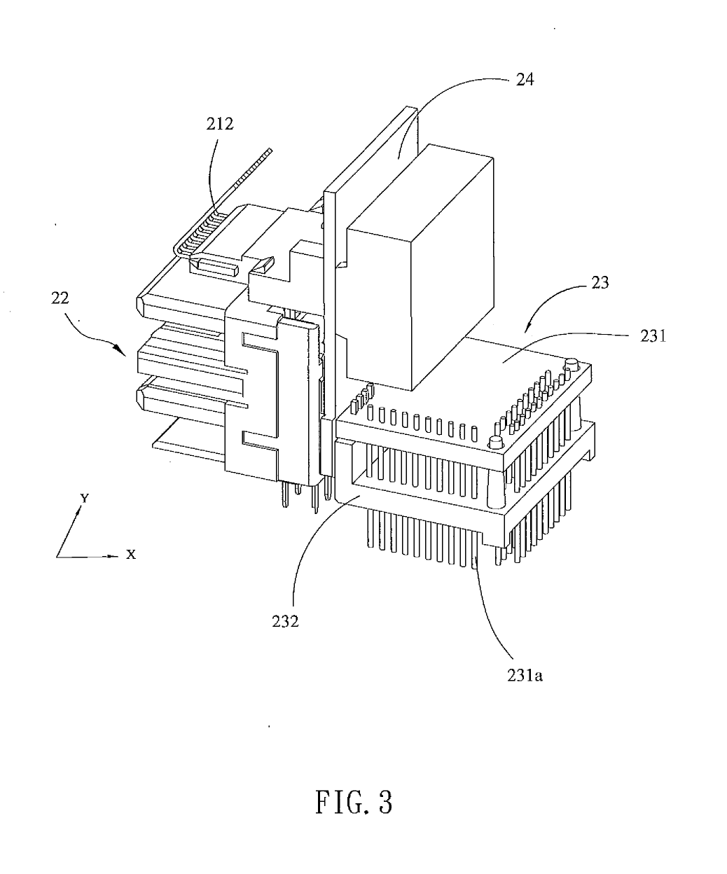

FIG. 2 is an exploded diagram of a connection module 2 of an embodiment of the invention. FIG. 3 is a schematic view of partial components shown in FIG. 2. With reference to FIG. 2 and FIG. 3, the connection module 2 of the invention includes a first connector 21, a second connector 22, a network element 23, a circuit board 24 and a housing 25. The first connector 21, the second connector 22 and the network element 23 are all disposed on the circuit board 24. The first connector 21 and the second connector 22 are disposed to a first side of the circuit board 24, and the network element 23 is disposed to a second side of the circuit board 24.

In the embodiment, the first connector 21 includes a connection hole 211 and a plurality of transmission terminals 212 disposed in the connection hole 211. One end of each transmission terminal 212 extends toward a direction X and is fixed on the circuit board 24. The other end of each transmission terminal 212 obliquely extends toward a direction Y from an entrance toward an inside of the connection hole 211. Furthermore, the type of the connection hole 211 is corresponding to the type of a plug to be plugged into the connection hole 211, for accommodating the plug. After the plug is plugged into the connection hole 211, the plug can be electrically connected to the transmission terminals 212 of the connection hole 211. In the embodiment, the connection hole 211 is, for example, an RJ-45 connection hole, an RJ-11 connection hole, an RJ-12 connection hole or any other type of connection hole. Correspondingly, the plug can be an RJ-45 plug, an RJ-11 plug, an RJ-12 plug or any other type of plug.

As shown in FIG. 2 and FIG. 3, the second connector 22 is disposed adjacent to the first connector 21. The second connector 22, for example, includes a USB transmission interface. Furthermore, the second connector 22 has a plurality of terminals (not shown) fixed on the circuit board 24 and electrically connected to an external plug. In the embodiment, the network element 23 is disposed on the circuit board 24. The first connector 21, the second connector 22 and the network element 23 are disposed in the housing 25. The network element 23 is used to modulate signals and information received by the connection module 2. The network element 23 includes a network chip 231 and a carrying element 232 which carries the network chip 231. The network chip 231, for example, is a physical layer (PHY) chip applied to a physical layer processing apparatus. Besides, the network element 23 has a plurality of pins 231a embedded to the carrying element 232. The pins 231 further protruding from the carrying element 232 and can be soldered with a pre-provided circuit board (not shown) for coupling with the circuit board 24.

To be noted, the first connector 21, the second connector 22 and the network element 23 are disposed in the housing 25 for saving space of the circuit board 24. Furthermore, the housing 25 has a plurality of openings 251 corresponding to the first connector 21 and the second connector 22, and a plurality of the grounding pins 252 extending from the bottom of the housing 25. In the embodiment, the connection module 2 uses the housing 25 to shield the first connector 21, the second connector 22 and the network element 23. As a result, the purpose of preventing EMI can be achieved. To prevent EMI, the housing 25 can include the EMI shielding material, or form the EMI shielding material on the surface thereof. The EMI shielding material can be, for example, metal or alloy. Compared with the prior art, the first connector 21, the second connector 22 and the network element 23 are integrated on the same circuit board 24, so that the EMI shielding can be achieved simultaneously. As described above, the EMI shielding can be achieved by the housing 25, thereby simplifying the design of EMI shielding mechanism.

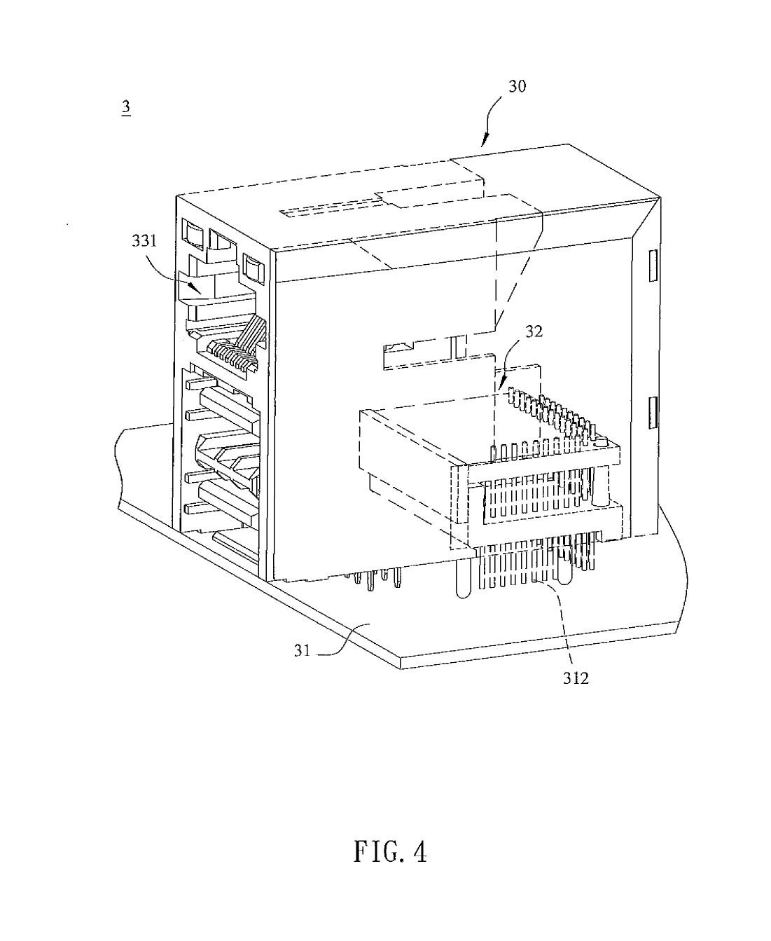

FIG. 4 is a three-dimensional diagram of a network device 3 according to the embodiment of the invention. The network device 3 includes a circuit board 31 and a connection module 30. Because the components, features and functions of the connection module 30 are the same as those of the previously mentioned connection module 2, the detailed descriptions thereof will be omitted.

In the embodiment, the connection module 30 is disposed on the circuit board 31 and electrically connected to the circuit board 31. In details, the connection module 30 is electrically connected to the circuit board 31 by pins 312. When the connection hole 331 of the connection module 30 is coupled with an external plug (not shown), the external network information received by the connection module 30 can be modulated by the internal network element 32 and transmitted through the pins 312 of the connection module 30 to the pre-provided circuits and other electronic elements on the circuit board 31.

In summary, the network element and connectors of the invention are integrated on one circuit board, and one housing is used to achieve the purpose of preventing EMI. Compared with the prior art, the connection module of the invention is disposed on one circuit board so that the area of the circuit board can be saved so as to meet the trend of microminiaturization. In addition, the connection module can be easily assembled with the circuit board, and thus simplify the circuit layout of the circuit board, thereby decreasing the manufacturing cost.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A connection module comprising:
at least a connector;
a circuit board, wherein the connector is electrically connected to a first side of the circuit board;
a network element electrically connected to a second side of the circuit board opposite to the connector; and
a housing accommodating the connector and the network element.

2. The connection module as recited in claim 1, wherein the network element comprises a network chip and a carrying element for carrying the network chip, and the network chip comprises a physical layer chip.

3. The connection module as recited in claim 2, wherein the network chip has a plurality of pins embedded in the carrying element and protruding from the carrying element, and the pins are soldered to a pre-provided circuit board for being electrically connected to the circuit board of the connection module.

4. The connection module as recited in claim 1, wherein the connector comprises a first connector and a second connector, and the first connector and the second connector arc located adjacent to each other and disposed on the circuit board.

5. The connection module as recited in claim 4, wherein the first connector comprises a connection hole and a plurality of transmission terminals disposed in the connection hole, and one end of each of the transmission terminals is coupled to the circuit board, and the other end thereof extends obliquely along a direction from an entrance toward an inside of the connection hole.

6. The connection module as recited in claim 4, wherein the connection hole of the first connector is an RJ-45 connector hole, an RJ-11 connector hole, or an RJ-12 connector hole.

7. The connection module as recited in claim 4, wherein the second connector comprises a USB transmission interface and a plurality of terminals coupled to the circuit board.

8. The connection module as recited in claim 4, wherein the housing has a plurality of openings disposed corresponding to the first connector and the second connector.

9. The connection module as recited in claim 1, wherein the housing has a plurality of grounding pins extending from a bottom of the housing.

10. The connection module as recited in claim 1, wherein the housing comprises an EMI shielding material or an EMI shielding material formed on a surface of the housing.

11. A network device comprising:
a first circuit board; and
a connection module comprising:
at least a connector;
a second circuit board, wherein the connector is electrically connected to a first side of the second circuit board;
a network element electrically connected to a second side of the second circuit board opposite to the connector; and
a housing accommodating the connector and the network element, wherein the connection module is coupled with the first circuit board.

12. The connection module as recited in claim 11, wherein the network element comprises a network chip and a carrying element for carrying the network chip, and the network chip comprises a physical layer chip.

13. The connection module as recited in claim 12, wherein the network chip has a plurality of pins embedded in the carrying element and protruding from the carrying element, and the pins are soldered to the first circuit board for electrically connecting to the first circuit board.

14. The connection module as recited in claim 11, wherein the connector comprises a first connector and a second connector, and the first connector and the second connector are located adjacent to each other and disposed on the second circuit board.

15. The connection module as recited in claim 14, wherein the first connector comprises a connection hole and a plurality of transmission terminals disposed in the connection hole, and one end of each of the transmission terminals is coupled to the second circuit board, and the other end thereof obliquely extends along a direction from an entrance toward an inside of the connection hole.

16. The connection module as recited in claim 15, wherein the first connector is an RJ-45 connector, an RJ-11 connector or an RJ-12 connector.

17. The connection module as recited in claim 14, wherein the second connector comprises a USB transmission interface, and the second connector comprises a plurality of terminals coupled to the second circuit board.

18. The connection module as recited in claim 14, wherein the housing has a plurality of openings disposed corresponding to the first connector and the second connector.

19. The connection module as recited in claim 11, wherein the housing has a plurality of grounding pins extending from a bottom of the housing.

20. The connection module as recited in claim 17, wherein the housing comprises an EMI shielding material or an EMI shielding material formed on a surface of the housing, and the EMI shielding material comprises metal or alloy.
